(19) United States
(12) Patent Application Publication
(10) Pub. No.: US 2012/0241571 A1
(43) Pub. Date: Sep. 27, 2012

(54) CONNECTOR SYSTEM FOR MEDICAL DEVICE

(75) Inventors: Edward Masionis, Toronto (CA); Veso Tijanic, Woodbridge (CA)

(73) Assignee: THORNHILL SCIENTIFIC INC., Toronto, ON (CA)

(21) Appl. No.: 13/395,624

(22) PCT Filed: Sep. 13, 2010
(86) PCT No.: PCT/CA2010/001422

§ 371 Date: May 22, 2012

Related U.S. Application Data
(60) Provisional application No. 61/241,864, filed on Sep. 11, 2009.
(60) Provisional application No. 61/242,375, filed on Sep. 14, 2009.
(60) Provisional application No. 61/305,541, filed on Feb. 17, 2010.

(51) Int. Cl. A61G 1/04; F16M 13/02

(52) U.S. Cl. 248/214; 248/205.1; 248/231.51; 248/225.11

(57) ABSTRACT

A connector system for connecting a medical device to a patient support device having first and second support members with a patient support panel disposed therebetween, wherein the connector system includes an anti-rotation arm connectably linked between the medical device and a support member connector connectable to the second support member. The anti-rotation arm is connected to the medical device in a manner that rotationally fixes the anti-rotation arm with the medical device with respect to rotation about the first support member for fixed rotational displacement with the medical device. In use, the anti-rotation arm rotationally fixes the medical device about the first support member.

### CROSS-REFERENCE TO RELATED APPLICATION

This application is a national phase filing, under 35 U.S.C. §371(c), of International Application No. PCT/CA2010/001422, filed Sep. 13, 2010, the disclosure of which is incorporated herein by reference in its entirety. International Application No. PCT/CA2010/001422, in turn, claims the benefit, under 35 U.S.C. §119(e), of U.S. provisional application Ser. No. 61/241,864, filed on Sep. 11, 2009; U.S. provisional application Ser. No. 61/242,375, filed on Sep. 14, 2009; and U.S. provisional application Ser. No. 61/305,541, filed on Feb. 17, 2010, the disclosures of all of which are incorporated herein by reference in their entireties.

### FIELD OF THE INVENTION

The present invention relates to connectors and more particularly to connectors for holding medical devices on stretchers, particularly for use in confined space such as a helicopter.

### BACKGROUND OF THE INVENTION

Stretchers and other support devices used to transport patients are often used to hold medical equipment. In some situations it is desirable to be able to move the medical devices between two or more positions to permit access to the patient, or to permit a person to pass by in a confined space. Structures proposed for holding medical devices in these environments have disadvantages and so new structures that address one or more of the issues described above would be advantageous.

### SUMMARY OF THE INVENTION

In military and emergency transport situations, stretchers and other support devices used to transport patients, often placed in helicopters and other transport vehicles, are exposed to conditions, the nature of which may transmit vibration to the structures holding the medical device. Structures proposed for holding medical devices in these environments have related disadvantages and so new structures that address these issues are proposed.

In one aspect, the invention is directed to a connector system for connecting a medical device to a patient support device having parallel, generally horizontal first and second support members and a patient support panel disposed between the first and second support members, the connector system comprising an anti-rotation arm connectably linked between:
the medical device, in a manner that rotationally fixes the anti-rotation arm with the medical device with respect to to rotation about first support member for fixed rotational displacement with the medical device;
   and a second support member connector connectable to the second support member;
   wherein, in use, the anti-rotation arm rotationally fixes the medical device about the first support member.

In one embodiment, the anti-rotation arm rotationally fixes the medical device about the first support member regardless of whether the first and second support member connectors are rotationally fixed about the first and second support members respectively.

In one embodiment, the first and second support members are frame members of a stretcher.

In one embodiment, the connector system comprises at least first and second support member connectors, wherein, when in use, at least of the first and second support member connectors permits lateral movement with the respective support member of the patient support device.

In one aspect, the invention is optionally directed to a connector system for connecting a medical device to a patient support device having parallel, generally horizontal first and second support members and a patient support panel disposed between the first and second support members, the connector system adapted for use with a first support member connector including a medical device connector portion and a first anti-rotation arm connection on the medical device or the first support member connector, the connector system comprising a second support member connector, an anti-rotation arm, and a second arm connection, wherein the anti-rotation arm is rotationally fixed with respect to the first support member connector and wherein the second support member connector, in use, rotationally fixes the medical device about the first support member.

In another aspect, the invention is optionally directed to a connector system for connecting a medical device to a patient support device having parallel, generally horizontal first and second support members and a patient support panel disposed between the first and second support members, the first support member having a substantially round cross sectional profile, the connector system comprising:

a second support member connector including a second support member engagement portion engageable with the second support member;

an anti-rotation arm connectable via a first arm connection to at least one of a medical device or a first support member connector affixing the medical device to the first support member, and connectable via a second arm connection to the second support member connector,

wherein, in use, the second support member connector, the anti-rotation arm, the first arm connection and the second arm connection are sufficiently rigid to rotationally fix the medical device about the first support member.

In one embodiment, the connector system comprises a first support member connector, including a medical device connector portion connectable to the medical device and a first support member engagement portion engageable with the first support member.

Thus in one aspect, the invention is directed to a connector system for connecting a medical device to a patient support device having parallel, generally horizontal first and second support members and a patient support panel disposed between the first and second support members comprising a first support member connector including a medical device connector portion, a second support member connector, an anti-rotation arm, a first arm connection and a second arm connection, wherein the anti-rotation arm is rotationally fixed with respect to the first support member connector and wherein the second support member connector, in use, rotationally fixes the medical device about the first support member.

It will be appreciated that some connections or engagements may be integrated or integrally formed and that subject to conveniences of portability, compactability (e.g. for shipping), timing of mounting or use, replaceability or flexibility in mounting, connectability, engageability or disassembly, at will, of certain parts does not limit the nature of the invention.

According to one aspect of the invention, the connector system imparts rotational stability to counter rotation of the device about the first support member to which it may be adjacent (often at one of more predetermined distances dictated by the intrinsic features of the connector system). Accordingly, despite unexpected torques, less than ideal support member engagement portions (by design or wear and tear) and/or partial loosening of the engagement with the first support member and/or the second support member to engender rotational play about a first support member (particularly where the first support member has a profile that does not inhibit rotation such a round profile, or more broadly speaking where the profile of first support member engagement portion does not match the profile of the first support member) the anti-rotation arm conveniently enable the connector system to compensate.

In one embodiment, or according to an entirely new aspect at least one of the first support member connector, the second support member connector, the anti-rotation arm, the first arm connection and the second arm connection permit relative lateral movement between the first support member and the second support member. Accordingly, in one aspect the invention is directed to a connector system comprising a second support member connector, an anti-rotation arm, and a second arm connection wherein at least one of the second support member connector, the anti-rotation arm, and the second arm connection permit relative lateral movement between the first support member and the second support member. In one embodiment the invention is directed to a connector system comprising a first support member connector, a second support member connector, an anti-rotation arm, a first arm connection and a second arm connection at least one of which permits relative lateral movement between the first support member and the second support member.

In one embodiment, the second support member connector includes a second support member engagement portion engageable with the second support member in such a way so as to substantially prevent vertical play therewith and permit lateral play therewith.

In a further embodiment, or according to an entirely new aspect, the invention is directed to a connector system comprising a slidable or extendable component to permit relative lateral movement of the first and second support arms of the stretcher.

As suggested above, the invention is also directed to a connector system comprising engageable or connectable components which are slidingly or variably engageable with the stretcher or with each other (or intrinsically or extrinsically extendable) such that the first and second support member move laterally with respect to another i.e. toward one another or away from one another, optionally, regardless of whether where the moving away occurs first or last (the moving away or the moving towards might also be limited to only to returning to an original position). For example, the first support member connector or the second support member connector may be slideably engageable with a support member of the stretcher. The anti-rotation arm may be intrinsically (spring loaded in a manner that accommodates suitable tension and compression properties or otherwise automatically extendable e.g. telescopable within limits) or extrinsically (manually adjustable) extendable. Especially, since some degree of stiffness of the ant-rotation arm is required to impart rotational stability, and particularly in an embodiment, where use of one anti-rotation arm only may be a feature of the device, the invention contemplates that slidable engagement or connection whether aided by part configurations, orientations, tolerances, variable movement latitudes and/or sizes accommodate this lateral play with attendant unexpected advantages including insulating the patient from the effects (sometimes including pain) of any movement and undesirable vibration and/or inhibiting loosening of connections or engagements.

Accordingly in another aspect, the invention is directed to a connector system for connecting a medical device to a patient support device having parallel, generally horizontal first and second support members and a patient support panel disposed between the first and second support members, the connector system comprising:

a first support member connector, including a medical device connector portion connectable to the medical device and a first support member engagement portion engageable with the first support member;

a second support member connector including a second support member engagement portion engageable with the second support member;

an anti-rotation arm connectable via a first arm connection to at least one of the first support member connector and the medical device, and connectable via a second arm connection to the second support member connector,

wherein, in use, at least one of the first support member connector, the second support member connector, the anti-rotation arm, the first arm connection and the second arm connection permit relative lateral movement between the first support member and the second support member.

Optionally, when the connector system is in use in relation to a support member of a patient support device and a medical device, at least one of the first support member connector, the second support member connector, the anti-rotation arm are slideably or variably extendable, usable, engageable or connectable.

According to another aspect the invention is directed to a connector system for connecting a medical device to a patient support device having parallel, generally horizontal first and second support members and a patient support panel disposed between the first and second support members, the first support member having a substantially round cross sectional profile, the connector system comprising:

a first support member connector, including a medical device connector portion connectable to the medical device and a first support member engagement portion engageable with the first support member in such a way so as to substantially prevent vertical play therewith;

a second support member connector including a second support member engagement portion engageable with the second support member in such a way so as to substantially prevent vertical play therewith; and

an anti-rotation arm connectable via a first arm connection to at least one of the first support member connector and the medical device, and connectable via a second arm connection to the second support member connector,

wherein, in use, the first support member connector, the second support member connector, the anti-rotation arm, the first arm connection and the second arm connection are sufficiently rigid to rotationally fix the medical device about the first support member regardless of whether the first and second support member connectors are rotationally fixed about the first and second support members respectively.

According to another aspect the invention is directed a connector system for connecting a medical device to a patient support device having parallel, generally horizontal first and second support members and a patient support panel disposed between the first and second support members, the first support member having a substantially round cross sectional profile, the connector system comprising:

a first support member connector, including a medical device connector portion connectable to the medical device and a first support member engagement portion engageable with the first support member;

a second support member connector including a second support member engagement portion engageable with the second support member; and

an anti-rotation arm connectable via a first arm connection to at least one of the first support member connector and the medical device, and connectable via a second arm connection to the second support member connector,

wherein, in use, the anti-rotation arm is linked to medical device to fixedly rotate therewith about the first support member and engageable with the second support member in such a way so as to substantially prevent vertical play therewith and permit lateral play therewith and wherein the second support sufficiently rigid to rotationally fix the medical device about the first support member.

### BRIEF DESCRIPTION OF THE DRAWINGS

The present invention will now be described by way of example only with reference to the attached drawings, in which:

FIG. 1 is a perspective view of a medical device, a stretcher and a set of connectors for connecting the medical device to the stretcher in accordance with an embodiment of the present invention;

FIG. 1b is magnified perspective view of joints 22 of the stretcher;

FIG. 2 is a magnified perspective view of one of the connectors shown in FIG. 1;

FIG. 3 is a magnified perspective view of another one of the connectors shown in FIG. 1;

FIG. 4 is an elevation view of the connector shown in FIG. 2 in a first position;

FIG. 5 is another elevation view of the connector shown in FIG. 2 in an intermediate position;

FIG. 6 is another elevation view of the connector shown in FIG. 2 in a second position;

FIG. 7 is an elevation view of a connector in accordance with another embodiment of the present invention;

FIGS. 8a-8f are elevation views of the connector shown in FIG. 2 illustrating a sequence of events from a connection to one side of the stretcher shown in FIG. 1 to the other side of the stretcher;

FIG. 9a is another magnified perspective view of the connector shown in FIG. 2; showing a support member connector with a limit member in a stowage position, showing a clamp with a limit member in a working position;

FIG. 9b is another magnified perspective view of the connector shown in FIG. 2, showing the clamp in a fully closed position with a limit member in a stowage position; and

FIG. 9c is another magnified perspective view of the connector shown in FIG. 2, showing the clamp in a fully open position;

FIGS. 10a-10d are perspective views showing a connector in accordance with another embodiment of the present invention;

FIG. 11 is a perspective view showing two of the connectors shown in FIGS. 10a-10d holding a medical device to a stretcher; and

FIGS. 12a and 12b are perspective views showing a connector in accordance with another embodiment of the present invention.

FIG. 13a is an exploded view of a connector coupling device that is adapted to be used in conjunction with a connector of the type shown in FIG. 2.

FIG. 13b is a magnified view of a clamp connector of the connector coupling device illustrated in FIG. 12a shown from a different perspective

FIG. 13c is an isometric view of the connector coupling device shown in FIG. 13a.

FIG. 13d is a magnified view of a stabilizer connector of the connector coupling device shown in FIGS. 13a and 13c.

### DETAILED DESCRIPTION OF THE INVENTION

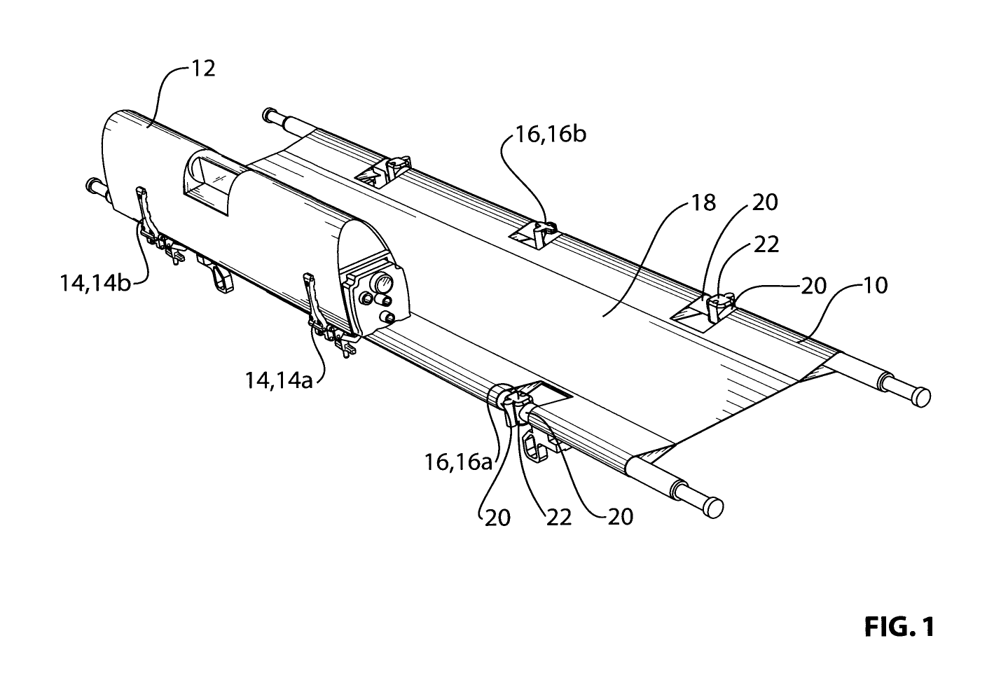

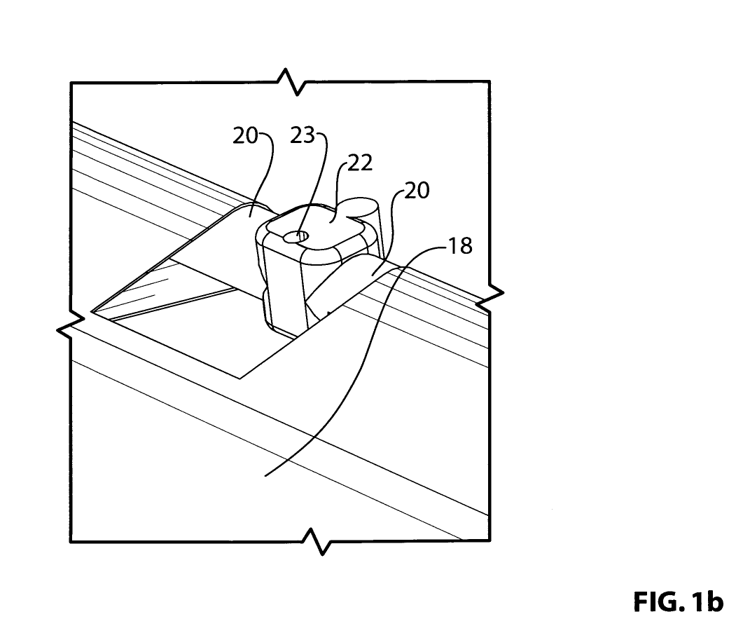

Reference is made to FIG. 1, which shows a stretcher 10, a medical device 12, and a set of connectors 14, individually shown at 14a and 14b, in accordance with an embodiment of the present invention. The stretcher 10 may be any suitable type of stretcher, such as a NATO litter. The stretcher 10 may include first and second support members 16, shown individually at 16a and 16b, and a patient supporting panel 18 supported between the first and second support members 16a and 16b.

The first and second support members 16a and 16b may be substantially identical but for being mirror images of one another. Each support member 16 may include a plurality of support member segments 20 that are connected to each other end-to-end via joints 22.

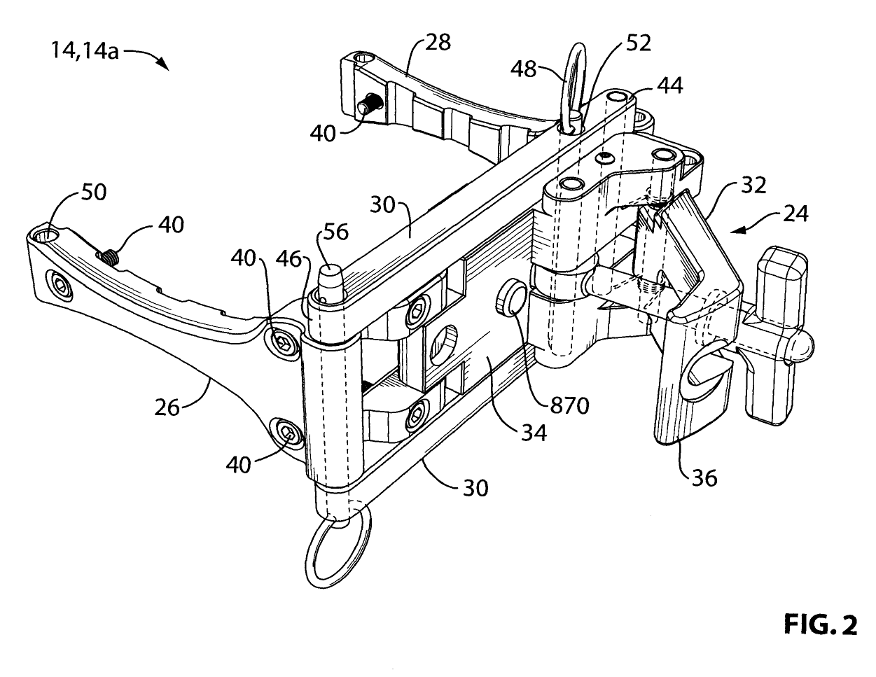

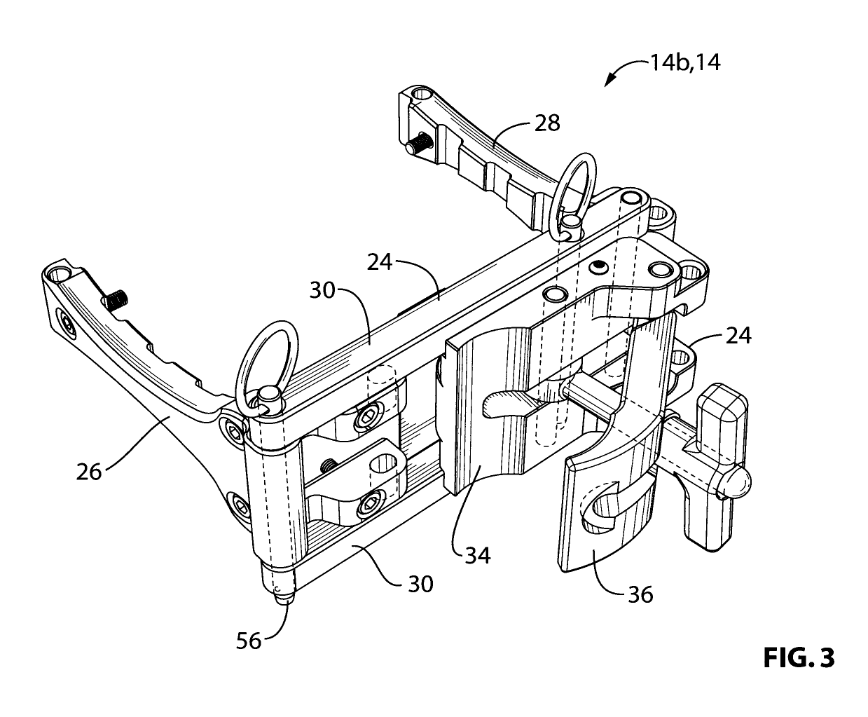

As described in detail in our published PCT application WO 2009/132458 (the entirety of which is hereby incorporated by reference). the connectors 14 are used to hold the medical device 12 on the stretcher 10 and may be referred to herein, for convenience, as medical device clamps. Referring to FIGS. 2 and 3, the connector 14a includes a support member connector 24, which may be any suitable type of connector, and may include, for example, a clamp 32. The clamp 32 may include an upper jaw 34 and a lower jaw 36 which may be configured to engage the knuckle or joint of a stretcher shown in detail in FIG. 1b. As seen in FIG. 1b, the joint 22 interconnecting support member segments 20 has a squared off surface that matches the shape of the upper jaw 34 and a recess 23 adapted to receive lug 870. To assist only rotational stability, the recess may also be configured as a suitably sized slot or indent the length of which may run parallel to the support member.

Alternatively, as shown in FIG. 3 the support member engaging surfaces of upper and lower jaws 34 and 36, respectively, may be have rounded support member engaging surfaces to clamp on to support members 16a or 16b at a some point along their length where is no joint.

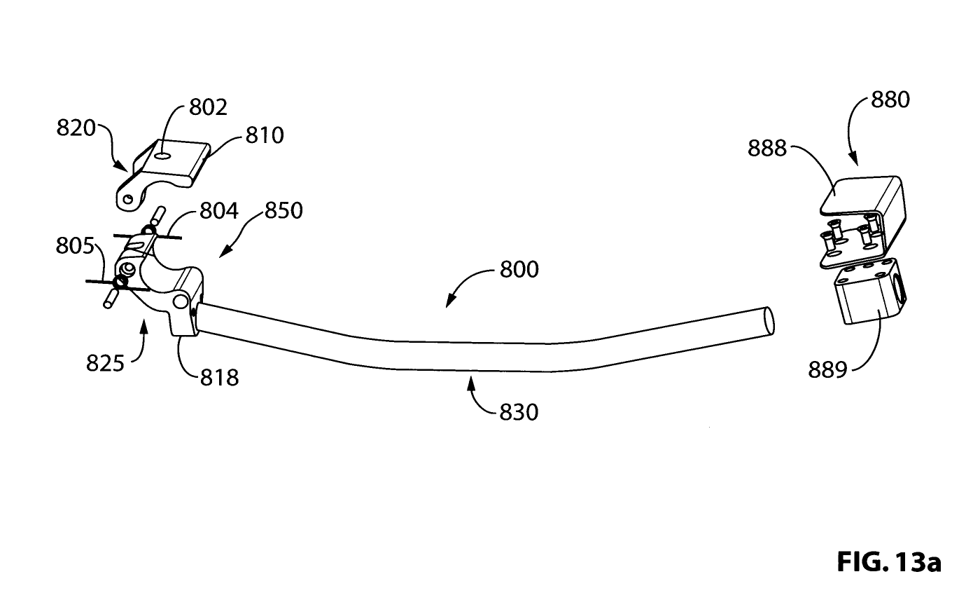

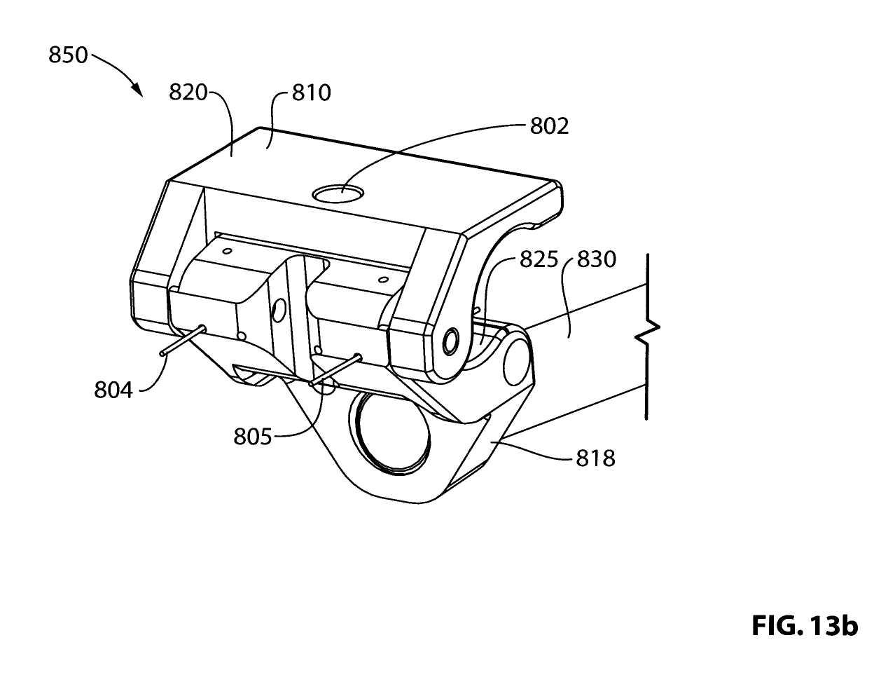

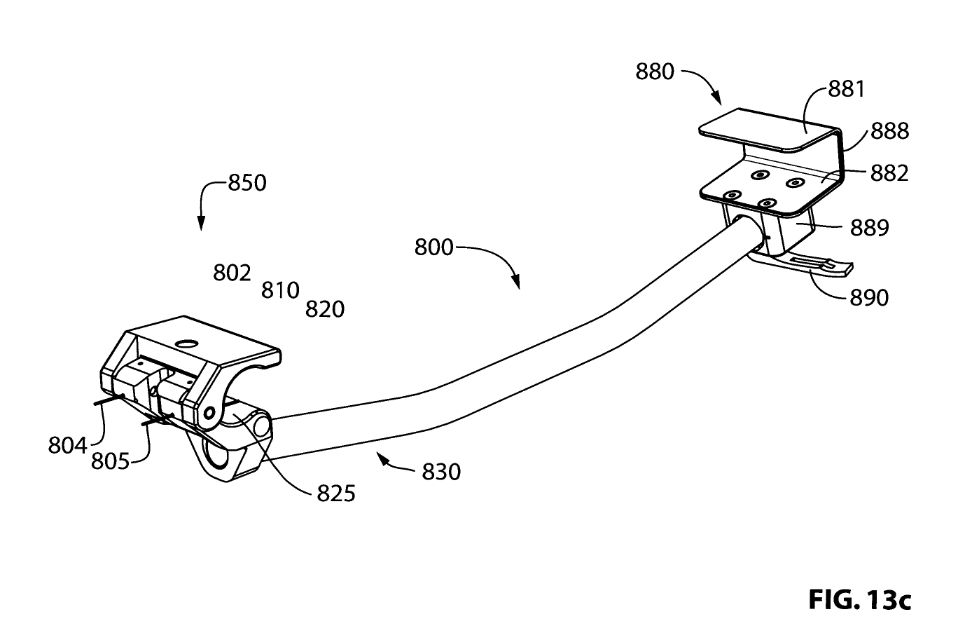

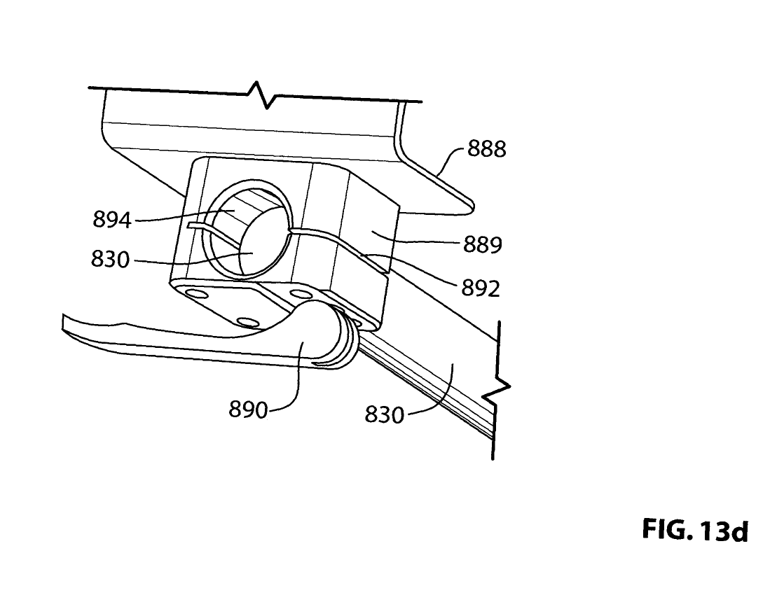

The joint or knuckle shown in detail in FIG. 1b, may not be a feature of some stretchers, and as explained below with reference to the connector assembly 800 shown in FIG. 13a, the connector system may comprise a first support member connector, including a first support member engagement portion that has a medical device clamp receiving surface, for example such as clamp connector 850, that is configured to simulate the shape of the joint 22 including a squared-off top surface 810 of its upper jaw 820 and a recess 802 corresponding is size and at least approximate position to recess 23 in joint 22 (elements optionally forming key parts of medical device clamp receiving surface).

As described in detail in published PCT application WO 2009/132458, and referring to FIG. 2 herein, the connector 14a includes a support member connector 24, a first device connector 26, a second device connector 28, and a pair of link arms 30. The support member connector 24 may be any suitable type of connector, and may include, for example, a clamp 32. The clamp 32 includes an upper jaw 34 and a lower jaw 36.

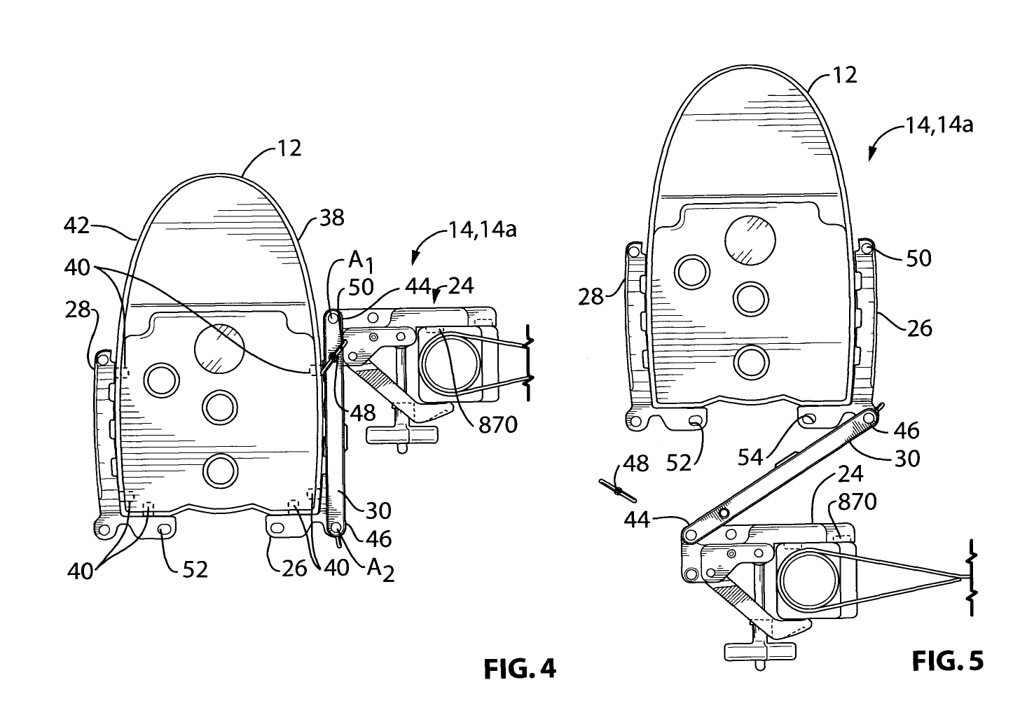

Referring to FIG. 4, the first device connector 26 is configured to fixedly connect to a first side 38 of the medical device 12 and may connect to the medical device 12 by any suitable means, such as by means of a plurality of threaded fasteners 40 mating with threaded apertures (not shown) on the medical device 12 (FIG. 1).

The second device connector 28 is configured to fixedly connect to a second side 42 of the medical device 12, which may be opposed to the first side 38, and may connect to the medical device 12 by any suitable means, such as by means of a plurality of threaded fasteners 40 mating with threaded apertures (not shown) on the medical device 12 (FIG. 1).

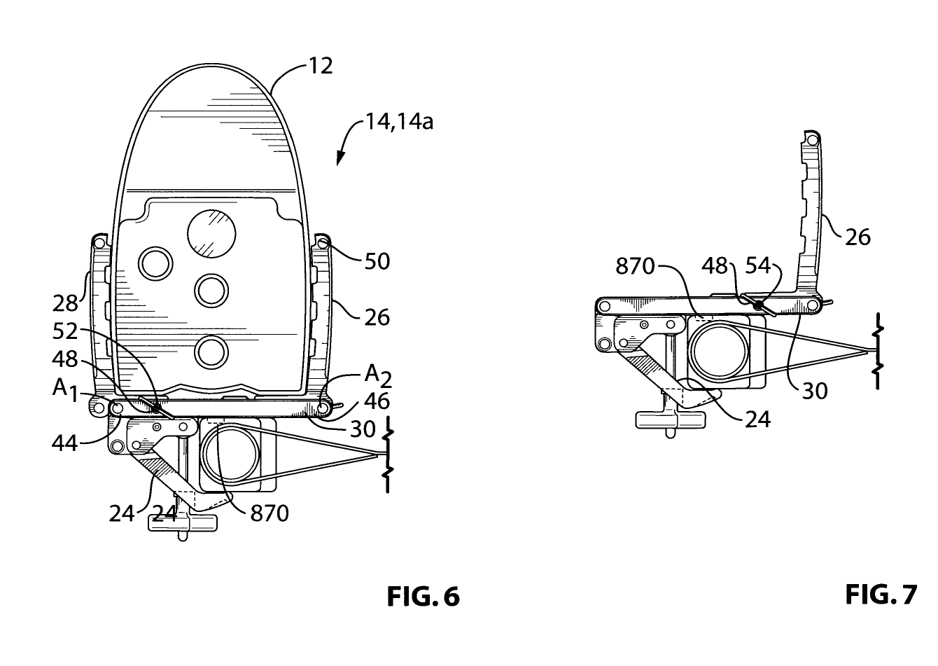

Referring to FIGS. 4, 5 and 6, the device connectors 26 and 28 are movable relative to the support member connector 24 between a first position shown in FIG. 4 wherein the device connectors 26 and 28 are positioned to hold the medical device 12 adjacent the stretcher 10 and a second position shown in FIG. 6 wherein the device connectors 26 and 28 are positioned to hold the medical device 12 above the stretcher 10. In the first position, the medical device 12 is off the patient support panel 18 so as not to impinge on the available space for a patient (not shown) on the stretcher 10. The second position is inboard of the first position so that the medical device 12 is less likely to interfere with the maneuvering of the stretcher 10 into position between stretcher-supporting stanchions (not shown) in a transport vehicle (not shown) such as a helicopter.

In an alternative embodiment that is not shown, it is possible for the second position to correspond to holding the medical device 12 and the device connectors 26 and 28 below the stretcher 10 instead of holding them above the stretcher 10. It is, however, preferable to hold them above the stretcher 10 for easier access by a medical device operator, such as a physician.

It will be noted that the orientation of the first and second device connectors 26 and 28 in the second position is the same as their orientation in the first position. This is advantageous in that the medical device 12 need not be reoriented for use when being moved between the first and second positions.

Movement between the first and second positions is achieved by means of the link arms 30. The link arms 30 each have a first end 44 and a second end 46. The support member connector 24 is rotatably connected to the first end 44 about a first axis A1 and one of the first and second device connectors 26 and 28 is rotatably connected to the second end 46 about a second axis A2. The axis A2 is preferably generally parallel to the axis A1.

A connector position locking pin 48 is provided to lock the connector 14a in each of the first and second positions. When the connector 14a is in the first position, the connector position locking pin 48 may pass through a first position locking aperture 50 that extends through the link arms 30, the support member connector 24 and the first device connector 26. When the connector 14a is in the second position, the connector position locking pin 48 may pass through a second position locking aperture 52 that extends through the link arms 30, the support member connector 24 and the second device connector 28, as shown in FIG. 6. The connector position locking pin 48 may be any suitable type of pin, such as a ball detent pin. Alternatively, any other suitable locking means may be provided.

To move from the first position (FIG. 4) to the second position (FIG. 6), the connector position locking pin 48 is removed from the first position locking aperture 50. The medical device 12 is moved from the position shown in FIG. 4 through the intermediate position shown in FIG. 5 to the position shown in FIG. 6. The connector position locking pin 48 is inserted into the second position locking aperture 52.

For the purposes of movement between the first and second positions and for holding the connector 14a in the first and second positions it will be noted that the second device connector 28 is not a necessary component and may be omitted. In such cases where the second device connector 28 is omitted, the connector position locking pin 48 may instead pass through an aperture shown at 54 that passes through the link arms 30, the support member connector 24 and the first device connector 26 (see FIG. 7).

While two link arms 30 are shown in the Figures, it will be apparent that any suitable number of link arms 30 may be provided, such as one link arm 30.

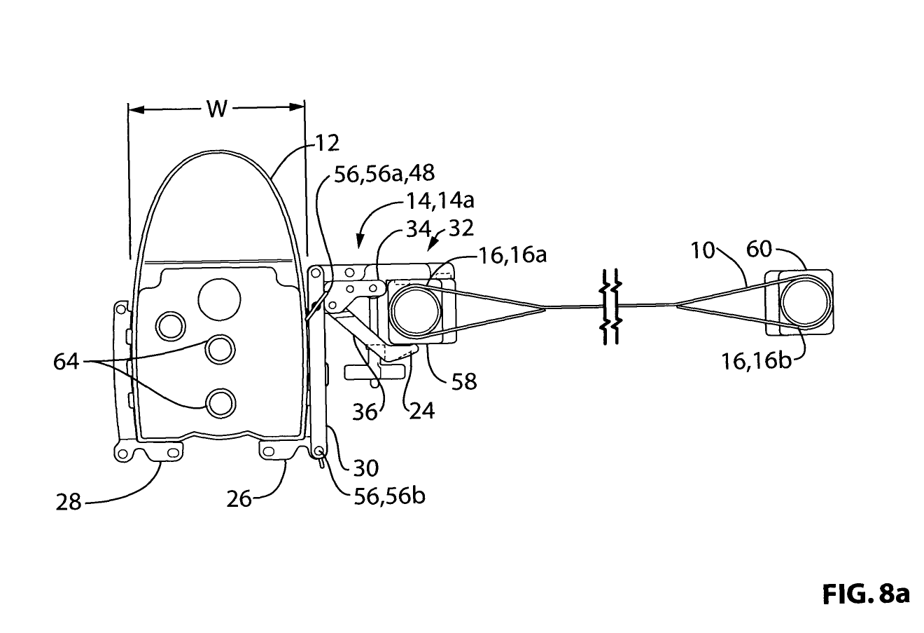

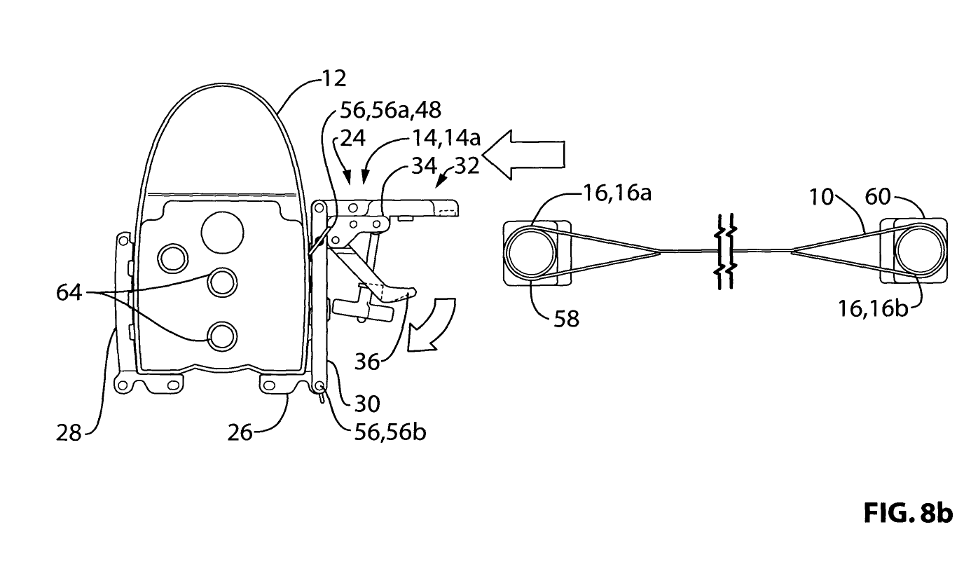

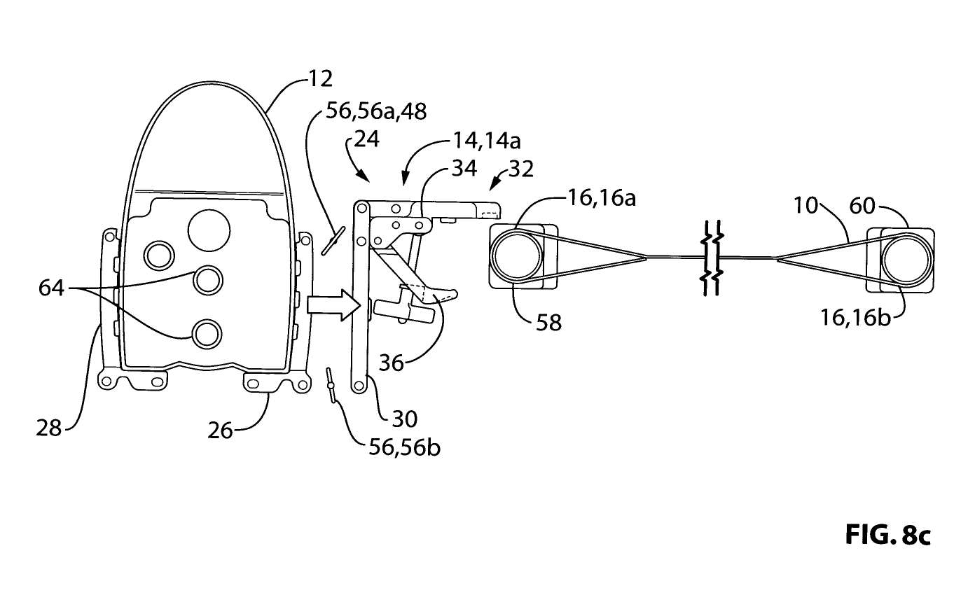

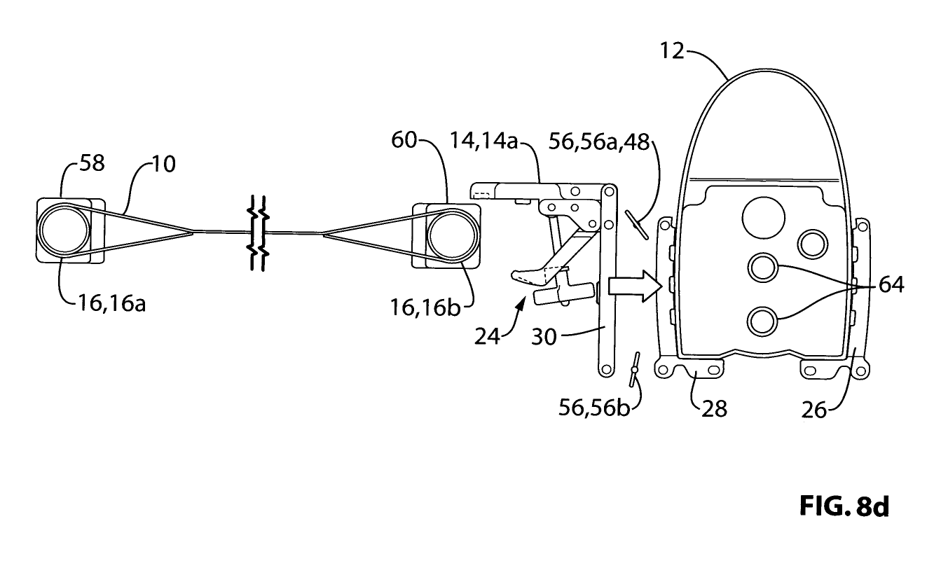

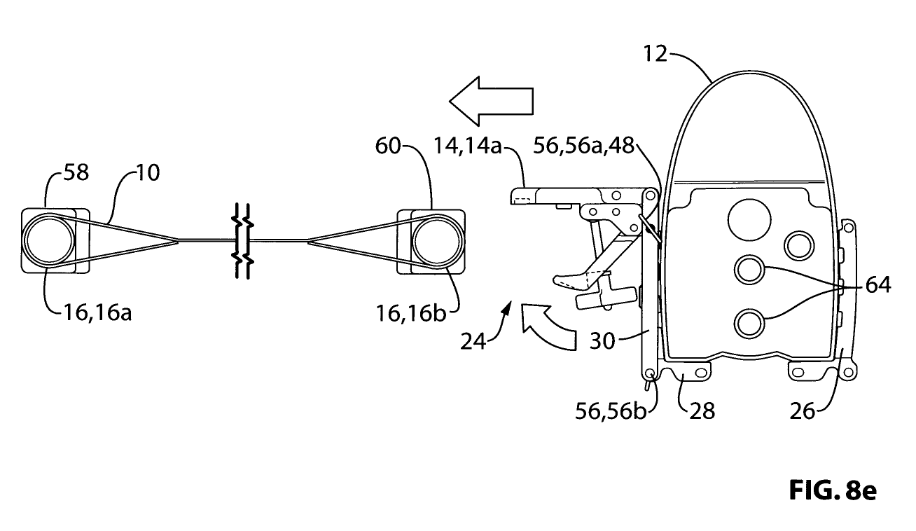

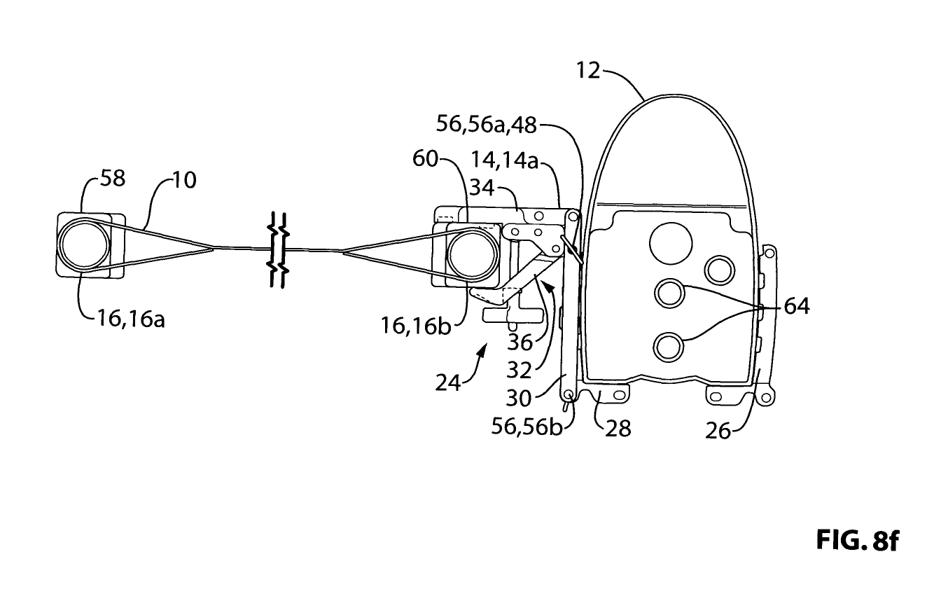

Referring to FIG. 2, the connector 14a may further include one or more support member connector orientation locking pins 56 that lock the support member connector 24 selectively in either a first orientation (FIG. 8a) relative to the device connectors 26 and 28 for mounting on a first side 58 of the stretcher 10, or a second orientation (FIG. 8f) relative to the device connectors 26 and 28 for mounting on a second side 60 of the stretcher 10. One of the support member connector orientation locking pins is shown at 56a and may be the connector position locking pin 48. Another support member connector orientation locking pin is shown at 56b and forms the rotatable connection between the link arms 30 and one of the first and second device connectors 26 and 28, thereby indirectly connecting the support member connector 24 to one of the first and second device connectors 26 or 28 (specifically the device connector 26 in FIG. 8a and the device connector 28 in FIG. 8f).

The sequence of Figures from FIG. 8a to FIG. 8f illustrates the removal of the medical device 12 from the first side 58 of the stretcher 10 and the remounting of it to the second side 60 of the stretcher 10. Specifically, FIG. 8a shows the medical device 12 and connector 14a connected to the support member 16a on the first side 58 of the stretcher 10. As shown in FIG. 8b, the medical device 12 and the entire connector 14a including the support member connector 24 may be removed from the support member 16a (egg. by opening of the clamp jaws 34 and 36 in embodiments wherein the support member connector 24 includes a clamp 32). As shown in FIG. 8c, the support member connector 24 is separated from the first device connector 26 by removal of the support member connector orientation locking pins 56. As shown in FIG. 8d, the support member connector 24 is reoriented from its first orientation (FIG. 8c) to its second orientation (FIG. 8d), which may be generally opposed to its first orientation. As shown in FIG. 8e, the support member connector orientation locking pins 56 are reinserted to lock the support member connector 24 to the second device connector 28, and to lock the connector 14a in the first position (i.e. so that the medical device is held adjacent the stretcher 10). As shown in FIG. 8f, the medical device 12 and the connector 14a are mounted to the support member 16b on the second side 60 of the stretcher 60 (e.g. by closing of the clamp jaws 34 and 36).

By quickly being able to change the orientation of the support member connector 24 on the connector 14, the medical device 12 can be moved easily and quickly from the left side of one stretcher 10 to the right side of another, while remaining in the same orientation. In this way, features that are desirable to have positioned close to a patient's head can be kept close to the patient's head regardless of whether the medical device 12 is on the left side or right side of the stretcher 10. For example, for certain types of medical device 12, a first end face 62 of the medical device 12 may include connections 64 for breathing tubes (not shown) from an oxygen mask (not shown). It is therefore desirable to have the first end 62 facing the patient's head (not shown). It is thus advantageous to be able to adjust the connectors 14 to permit the medical device 12 to be mounted to either side of the stretcher 10 while maintaining its orientation.

It will be noted that the sequence of events illustrated in FIGS. 8a-8f need not take place precisely in the order shown. For example, it is alternatively possible to initially remove the medical device 12 and the attached device connectors 26 ad 28 from the support member connector 24 while the support member connector 24 remains connected to the first side 58 of the stretcher 10, and then to remove the support member connector 24 from the stretcher 10. Similarly, it is possible to mount the support member connector 24 to the second side 60 of the stretcher 10 prior to locking of the medical device 12 and associated device connectors 26 and 28 to the support member connector 24 by means of the support member connector orientation locking pins 56.

To return the medical device 12 from the second side 60 of the stretcher 10 to the first side 58, the steps illustrated in FIGS. 8a-8f may be taken in reverse.

Once the support member connector orientation locking pin 56b is in place and connects the link arms 30 to one of the device connectors 26 and 28, the connector 14a is selectively movable between its first and second positions to hold the medical device 12 adjacent to or on top of the stretcher 10.

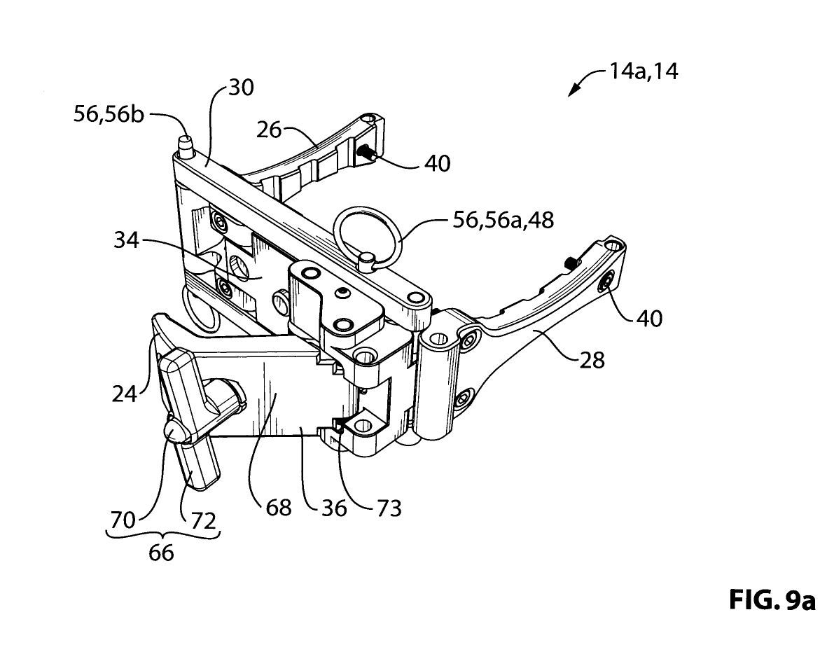

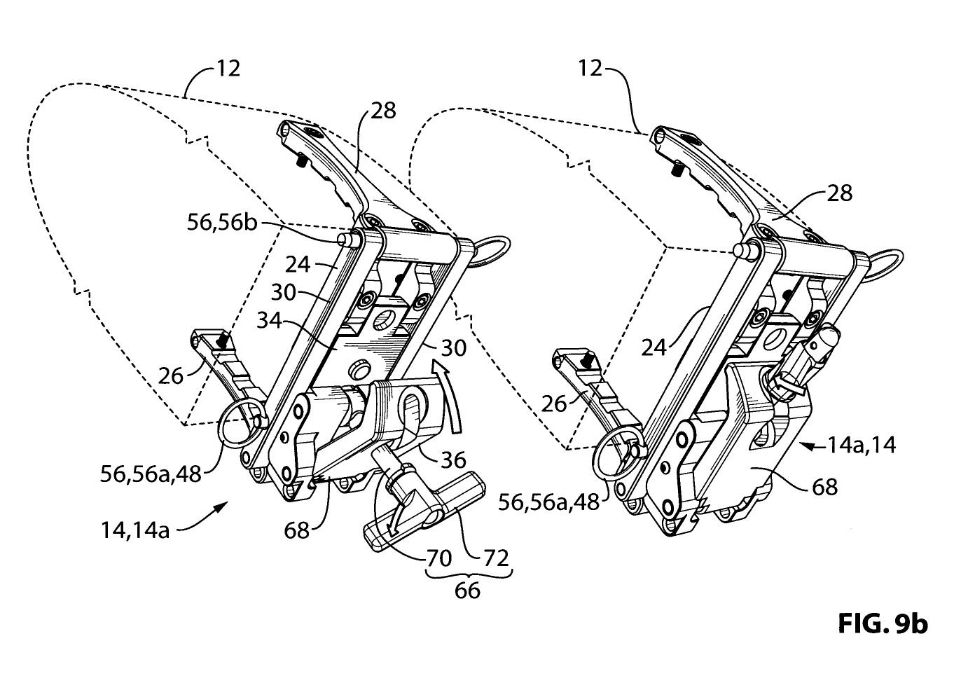

Reference is made to FIGS. 9a, 9b and 9c which show the support member connector 24 in more detail. The support member connector 24 may include the aforementioned clamp 32 and a limit member 66. The clamp jaws 34 and 36 are movable between a fully open position (FIG. 9a) and a fully closed position (FIG. 9b). The limit member 66 is movable between a working position (FIGS. 9a or FIG. 9c) and a stowed position (FIG. 9b). In the working position, the limit member 66 limits opening of the clamp jaws 34 and 36 beyond a selected maximum opening size (e.g. an example of which is shown in FIG. 9c) towards the fully open position. In the stowed position, the limit member 66 is rotated out of the way so that when the connector 14a is in the second position and the medical device 12 with attached connector 14a is placed on a support surface (e.g. a floor, not shown), a generally horizontal floor engaging surface 68 on the connector 14a engages the floor to support the medical device 12. The floor engaging surface 68 may be any selected part of the connector 14a, such as, for example, the underside of the lower clamp jaw 36.

The limit member 66 may have any suitable structure. For example, the limit member 66 may be made up of a threaded rod 70 and a handle 72 that is internally threaded for movement along the length of the threaded rod 70 and which is engageable with the lower clamp jaw 36 to set the selected maximum opening size of the clamp jaws 34 and 36. In a preferred embodiment, the threaded rod passes through an aperture in the lower jaw and is captured so that there is no way for the lower jaw 36 to bypass the handle 72.

It is alternatively possible to have the threaded rod 70 pivotally connected to the lower clamp jaw 36 and to have the handle 72 engage the upper clamp jaw 34.

The clamp jaws 34 and 36 may be biased towards their fully open position. To this end a clamp jaw biasing member 73 may be provided, which may be any suitable type of biasing member, such as, for example, a torsion spring.

Reference is made to FIG. 1. The connector 14b may be similar to the connector 14a, but is configured to hold the support member 16 at a different position than the connector 14a. For example, the connector 14a may be configured to hold the support member 16 at a joint 22, whereas the connector 14b may be configured to hold the support member 16 along a support member segment 20. For example, the joint may include a flat surface and a recess, which are exemplary embodiments of an anti-rotation feature of the support member 16. Accordingly, the shapes of the clamp jaws 34 and 36 may be slightly differently configured on the connector 14a than on the connector 14b to accommodate the particular portions of the support member 16 that each connector 14 clamps onto. FIG. 3 shows the clamp 32 on the connector 14b in more detail.

In the figures and description a stretcher 10 has been used to illustrate the operation of the connectors 14. It is alternatively possible for the stretcher 10 to be some other suitable type of patient support device, such as a gurney or a hospital bed.

In the figures, the first and second device connectors 26 and 28 have been shown to be two separate members that mount individually to the medical device 12. It is alternatively possible for the two device connectors 26 and 28 to be integrally connected together in a single U-shaped member.

The medical device 12 may be any suitable type of medical device, and may be configured to provide diagnostic information concerning the patient or may be configured to provide some form of treatment (e.g. oxygen) to the patient or may be configured to provide both diagnostic information and treatment to the patient.

The figures show two connectors being used to connect the medical device 12 to the stretcher 10. It is alternatively possible for any other suitable number of connectors 14 to be used. For example, it is possible that a single connector 14 could be used, or alternatively three or more connectors 14 could be used.

The medical device 12 could be configured to receive the link arms 30 directly instead of receiving the device connectors 26 and 28. In such an embodiment, whatever means are provided to connect the link arms 30 to the medical device 12 could be considered to be device connectors. For example, if bolts (not shown) are provided that each have an unthreaded portion that acts as a shaft for a link arm 30 and that has a threaded portion for mounting in a threaded aperture in the medical device 12 then the bolts would be considered to be device connectors.

The configuration of the medical device 12 is preferably relatively narrow in width. The width is shown in FIG. 8a as W. By having a narrow width, the medical device 12 occupies less pass-through space beside the stretcher 10 when the medical device 12 is positioned beside the stretcher 10, and also occupies relatively little patient support area on the stretcher 10 when the medical device 12 is positioned above the stretcher 10.

As a result of the narrow width W of the medical device 12, the medical device 12 may be elongate in order for it to contain all the desired components, and may be relatively tall. By extending the length and/or height of the medical device 12 the width W can be kept relatively narrow.

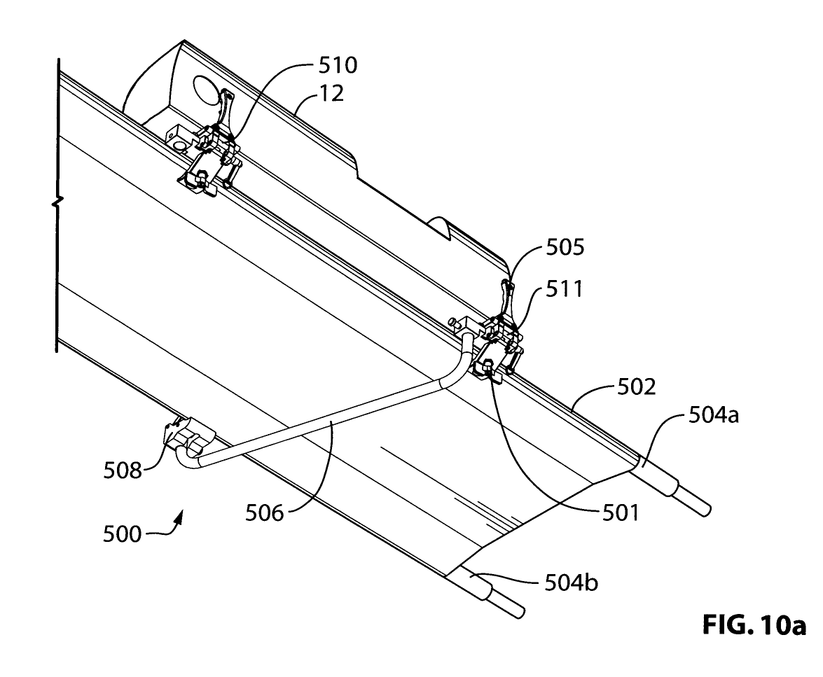

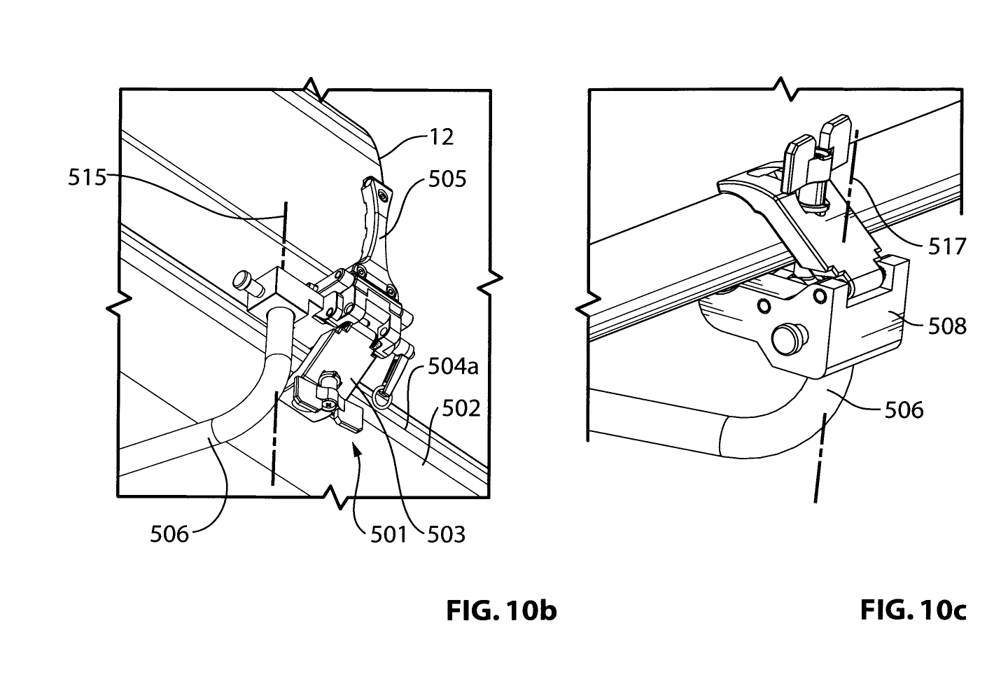

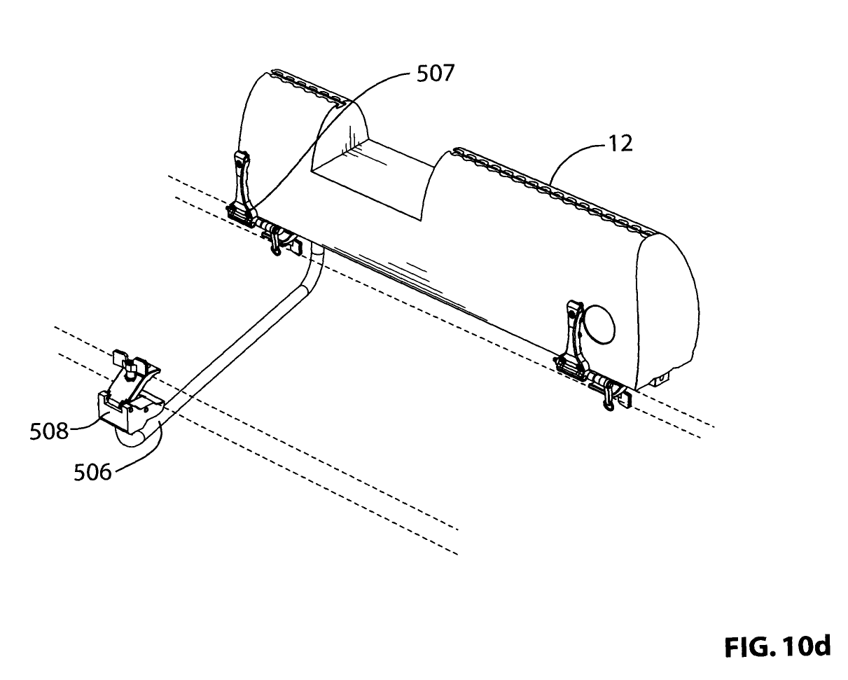

Reference is made to FIGS. 10a, 10b, 10c and 10d, which show a connector system 500 in accordance with another embodiment of the present invention, suited for use with stretchers 502 with support members 504a and 504b that are, for example, simple cylindrical members. In FIGS. 10a-10d, the connector system 500 includes a main connector or a first support member connector 501 that includes a first support member engagement portion, for example, a clamp which is releasably rotationally fixable with respect to the first support member, comprising a support member connector 503, that connects (e.g. clamps) to the support member 504a, and that further includes a medical device connector portions, for example first and second device connectors 505 and 507 (seen in FIG. 10d), and as such may be similar to the connector 14 (FIG. 1). The connector system 500 however further includes an anti-rotation arm, for example, a rigid cross-arm 506, a first arm connection for receiving the anti-rotation arm and a second support member connector, for example. in the form of a stabilizer connector 508 that connects to the second support member 504b on the other side of the stretcher 502. In this way the medical device 12 is prevented from rotating as a result of slippage of the support member connector 503 on the cylindrical support member 504a. In the embodiment shown in FIGS. 10a-10d, the cross-arm 506 shown in FIG. 10a connects at one end to the main connector portion or first support member connector 501, via a first arm connection, and connects at the other end, via a second arm connection, to the stabilizer connector 508. Optionally, in the embodiment shown in FIGS. 10a-10d the anti-rotation arm in the form of cross-arm 506 connects pivotally about a vertical axis 515 at the end connected to the main connector portion 501, and pivotally about a vertical axis 517 at the end connected to the stabilizer connector 508. In this way, the cross arm 506 can accommodate stretchers of different widths.

In the embodiment shown in FIGS. 10a-10d, the cross-arm 506 extends underneath the stretcher 502 so as not to obstruct access to the top of the stretcher where the patient is located (not shown). As shown in FIG. 10a, only one of the connectors shown is a connector system 500 which includes the anti-rotation arm (cross-arm 506) and a second support member connector (the stabilizer connector 508) including a second support member engagement portion which is rotationally fixable with respect to the second support member. The other connector (which may form part of the system) is shown at 510 and may be similar to the connector 14 shown in FIG. 1.

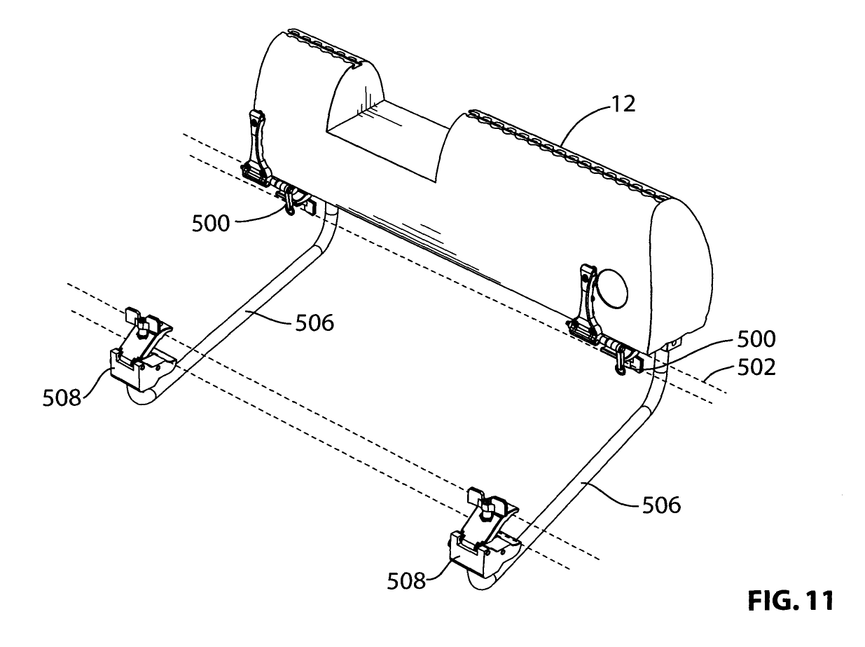

Optionally, as shown in FIG. 11, both of the first support member connectors for holding the medical device 12 to the stretcher 502 may be connectors that form part of a connector system 500 and thus may both be equipped with anti-rotation arms, for example, cross-arms 506 and second support member connectors, for example, the stabilizer connectors 508.

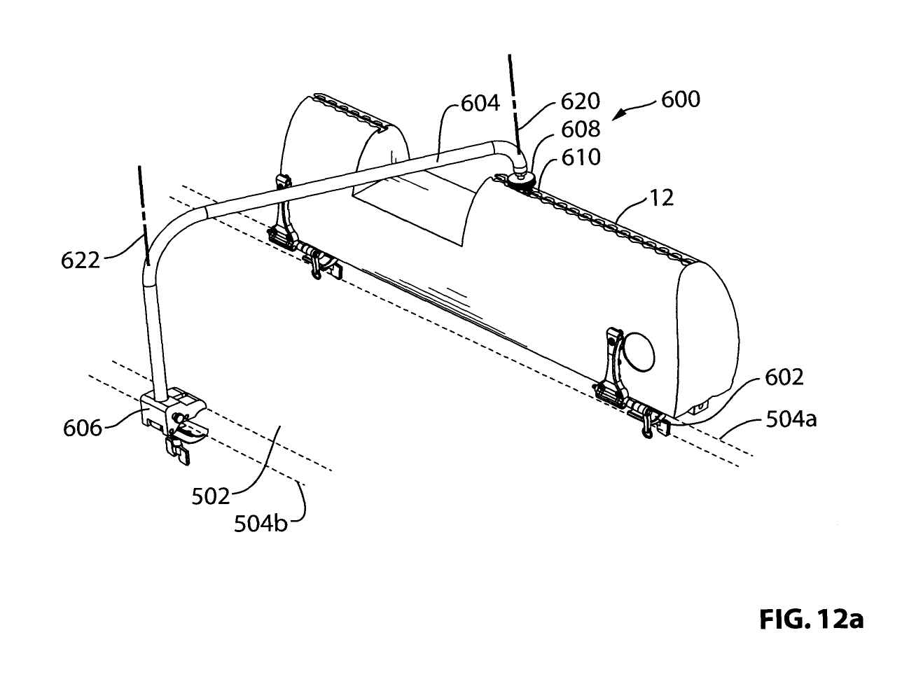

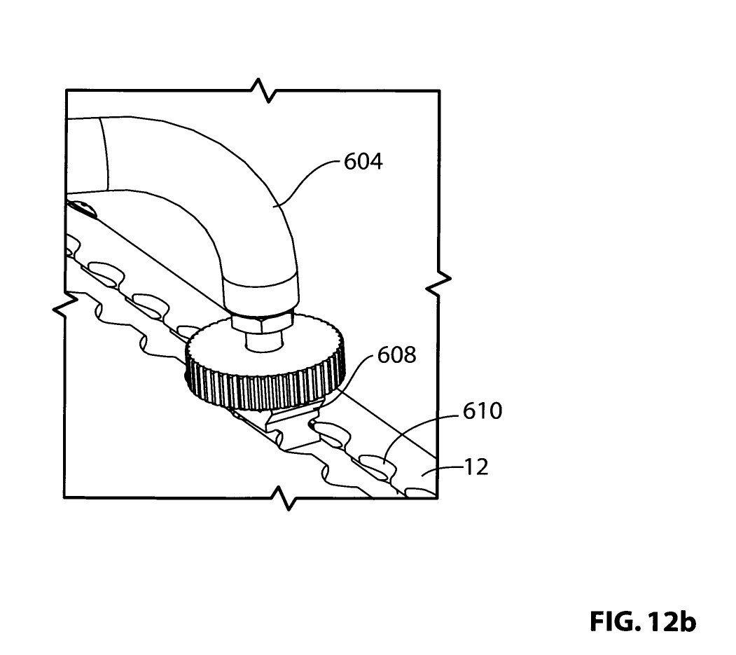

Referring to FIG. 12, a connector system 600 is shown as an alternative to the connector system 500 for connecting to the stretcher 502. The connector system 600 may includes a pair first support member connectors in the form main connector portion 602 that may be similar to the connector 14 shown in FIG. 1, but principally includes an anti-rotation arm e.g. cross-arm 604 and second support member connector in the form of a stabilizer connector 606. Referring to FIG. 12b, the cross-arm 604 extends above the stretcher 502 and connects at one end to the medical device 12, optionally via a connector 608 that is similar to that which is described as life support device connector shown at 804 in FIG. 25a of PCT application publication WO2008/052364 (Fisher et al), and which is held in a channel 610 on the medical device 12, that is similar to the channels shown at 870 in FIG. 27a of the aforementioned PCT application publication. Referring to FIG. 12a, the cross-arm 604 connects at its other end to the stabilizer connector 606 which is similar to the stabilizer connector 508 (FIGS. 10a-10d) and which connects to the other support member 504b of the stretcher 502. Similarly to the embodiment shown in FIGS. 10a-10d, the cross arm 604 may optionally be pivotable at each end about a vertical axis. The vertical axis is shown at 620 at the end connected to the medical device 12 and at 622 at the end connected to the stabilizer connector 606.

Referring to FIGS. 13a, 13b and 13c, the connector system comprising the connector coupling device 800 comprises a first support member connector, for example, a clamp connector 850, an anti-rotation arm e.g. cross arm 830 and a second support member connector, for example, a stabilizer connector 880. The first support member connector optionally comprises at least one medical device clamp receiving surface. For example, the clamp connector 850 comprises an anti-rotation feature, for example, a flat or a squared off surface and optionally a recess 802 that is positioned on the upper jaw 820 of the clamp connector in a location that enables the upper jaw 820 including its top surface 810 and the lower jaw 825 to substantially simulate the profile (though not necessarily the exact size) of a standard joint 22 (shown in FIG. 1) of a stretcher. In this way the projection or lug 870 of the connector shown in FIG. 2 can fit over the clamp connector 850 as though it were a joint of a stretcher with the lug 870 fitting within recess 802. The connector coupling device 800 is thereby adapted to work with a connector having a jaw profile of the type shown in FIG. 2 (with projecting lug 870).

The first support member connector in the form of clamp connector 850 is optionally adapted to be associated with a biasing means (804/805) to bias the upper jaw 820 towards the lower jaw 825. For example, the clamp connector 850 may be adapted to receive springs 804 and 805 to enable the connector coupling device 800 to exert a moderate clamping force on the support members 20 (which are typically covered with the canvass loops of the patient support surface) of a standard stretcher (shown in FIG. 1) of the type that does not have the joint 22.

The clamp connector 850 also includes a first arm connection, for example, a cross arm receiving portion 818. Cross arm 830 and stabilizer connector 880 are analogous in function to the cross-arm 506 and the stabilizer connector 508 shown in FIG. 10a. The stabilizer connector 880 includes a sleeve portion 888. The second support member connector comprises a second support member engagement portion that is optionally configured as sleeve portion 888 that provides the stabilizing function of the stabilizer connector 880 without clamping on the support member 16b (504b in FIG. 10a) of the stretcher (the second support member). The distance between the upper portion 881 and the lower portion 882 of the sleeve portion 888 may be selected to exceed the diameter of the support member 16b/504b by an amount that confers the desired limits on the rotational movement of cross member 830 about the axis of the opposite support member 16a (504a in FIG. 10a) to which clamp connector 850 is attached (about the first support member). The sleeve portion is otherwise configured (oriented and deep enough) to receive the second support member 16b/54b to a variable extent to as permit lateral movement of the first and second support members (54a and 54b) towards one another. This enables some vibration of the stretcher and movement of the patient to be tolerated by the connector system. The stabilizer connector 880 also includes a second arm connection, for example, cross arm receiving portion 889 which is optionally fitted with its own releasable clamp or clamping mechanism 890 (for example of the type used to adjust the height of a bicycle seat—see FIGS. 13c and 13d) so that it can be readily adjusted along the length of the cross arm 830 (to receive a variable amount of the length of the cross arm) as patients of different weight will impact the distance between opposite stretcher members 20, differently.

As seen in FIG. 13d the releasable clamp in the form of quick release camming lever 890 enables the cylindrical inner surface 894 of the cross arm receiving portion 889 to be clamped down on the cross arm 830 in virtue of the play provided by horizontal slit 892 in receiving portion 889.

While the above description constitutes a plurality of embodiments of the present invention, it will be appreciated that the present invention is susceptible to further modification and change without departing from the fair meaning of the accompanying claims.

1-40. (canceled)

41. A connector system for connecting a medical device to a patient support device having parallel, generally horizontal first and second support members and a patient support panel disposed between the first and second support members, the first support member having a substantially round cross sectional profile, the connector system comprising:
a first support member connector, including a medical device connector portion connectable to the medical device and a first support member engagement portion engageable with the first support member in such a way so as to substantially prevent vertical play therewith;
a second support member connector including a second support member engagement portion engageable with the second support member in such a way so as to substantially prevent vertical play therewith; and
an anti-rotation arm connectable via a first arm connection to the first support member connector, and connectable via a second arm connection to the second support member connector,
wherein, in use, the first support member connector, the second support member connector, the anti-rotation arm, the first arm connection and the second arm connection are sufficiently rigid to rotationally fix the medical device about the first support member regardless of whether the first and second support member connectors are rotationally fixed about the first and second support members respectively.

42. A connector system as claimed in claim 41, wherein the first and second support members are frame members of a stretcher.

43. A connector system as claimed in claim 42, wherein the first support member engagement portion is a clamp.

44. A connector system as claimed in claim 42, wherein at least one of the first support member connector, the second support member connector, the anti-rotation arm, the first arm connection and the second arm connection permit relative lateral movement between the first support member and the second support member.

45. A connector system as claimed in claim 44, wherein at least one of the first and second support member engagement portions, when in use, permits lateral movement of the respective support member of the patient support device.

46. A connector system as claimed in claim 41, wherein at least one of the first and second support member engagement portions has a generally U-shaped mouth for receiving the respective support member of the patient support device and wherein the U-shaped mouth is oriented to permit lateral movement of the second support members towards the first support member, when in use.

47. A connector system as claimed in claim 45, wherein one of the first and second support member engagement portions is rotationally fixable to the respective support member of the patient support device.

48. A connector system as claimed in claim 47, wherein the first support member engagement portion is releasably rotationally fixable to the respective support member of the patient support device.

49. A connector system as claimed in claim 41, wherein at least one of the first and second arm connections includes a releasable clamp that is lockable to the anti-rotation arm over a lateral range of positions, so as to permit selection of the lateral spacing between the first and second support member engagement portions.

50. A connector system as claimed in claim 43, wherein the clamp has an upper jaw and lower jaw and wherein at least one of the upper and lower jaws are movable relative to the other of the upper and lower jaws to move the clamp between a clamp closed position and a clamp open position.

51. A connector system as claimed in claim 50, wherein the upper and lower jaws are shaped to mate with an anti-rotation feature on the first support member.

52. A connector system as claimed in claim 41, wherein the medical device connector portion is sized to be clamped by a medical device clamp on the medical device, and wherein the medical device connector portion has a recess therein and the medical device clamp has a lug that fits in the recess in the medical device connector portion when the medical device clamp is clamped to the medical device connector portion, so as to fix the medical device rotationally relative to the first support member connector about the first support member.

53. A connector system as claimed in claim 41, wherein the first support member engagement portion comprises an upper jaw and a lower jaw, wherein the upper and lower jaws have upper and lower medical device clamp receiving surfaces respectively which are positioned to cooperate with the medical device clamp such that, in use, clamping of the medical device clamp onto the upper and lower medical device clamp receiving surfaces rotationally fixes the medical device relative to the first support member connector about the first support member, and clamps the upper and lower jaws onto the first support member to rotationally fix the first support member connector about the first support member.

54. A connector system as claimed in claim 41, wherein at least one of the first support member connector, the second support member connector, the anti-rotation arm, the first arm connection and the second arm connection permit relative lateral movement between the first support member and the second support member.

55. A connector system as claimed in claim 54, wherein the first support member engagement portion is a clamp having an upper jaw and lower jaw and wherein at least one of the upper and lower jaws are movable relative to the other of the upper and lower jaws to move the clamp between a clamp closed position and a clamp open position.

56. A connector system as claimed in claim 55, wherein the upper and lower jaws are shaped to mate with an anti-rotation feature on the first support member.

57. A connector system for stabilizing a medical device on a patient support device having parallel, generally horizontal first and second support members and a patient support panel disposed between the first and second support members, the first support member having a substantially round cross sectional profile, wherein the medical device is connectable to the first support member by a medical device connector, the connector system comprising:
a second support member connector including a second support member engagement portion engageable with the second support member in such a way so as to substantially prevent vertical play therewith; and
an anti-rotation arm connectable via a first arm connection to the medical device, and connectable via a second arm connection to the second support member connector,
wherein, in use, the second support member connector, the anti-rotation arm, the first arm connection and the second arm connection are sufficiently rigid to rotationally fix the medical device about the first support member regardless of whether the medical device connector and the second support member connector are rotationally fixed about the first and second support members respectively.

58. A connector system as claimed in claim 57, wherein the first and second support members are frame members of a stretcher.

59. A connector system as claimed in claim 58, wherein the medical device connector is a clamp.

60. A connector system as claimed in claim 58, wherein at least one of the second support member connector, the anti-rotation arm, the first arm connection and the second arm connection permit relative lateral movement between the first support member and the second support member.

61. A connector system as claimed in claim 60, wherein the second support member engagement portion, when in use, permits lateral movement of the second support member of the patient support device.

62. A connector system as claimed in claim 57, wherein the second support member engagement portion has a generally U-shaped mouth for receiving the second support member of the patient support device and wherein the U-shaped mouth is oriented to permit lateral movement of the second support members towards the first support member, when in use.

63. A connector system as claimed in claim 57, wherein at least one of the first and second arm connections includes a releasable clamp that is lockable to the anti-rotation arm over a lateral range of positions, so as to permit selection of the lateral spacing between the medical device and the second support member engagement portion.

64. A connector system as claimed in claim 57, wherein the medical device connector portion is sized to be clamped by a medical device clamp on the medical device, and wherein the medical device connector portion has a recess therein and the medical device clamp has a lug that fits in the recess in the medical device connector portion when the medical device clamp is clamped to the medical device connector portion, so as to fix the medical device rotationally relative to the first support member connector about the first support member.

65. A connector system as claimed in claim 57, wherein the first support member engagement portion comprises an upper jaw and a lower jaw, wherein the upper and lower jaws have upper and lower medical device clamp receiving surfaces respectively which are positioned to cooperate with the medical device clamp such that, in use, clamping of the medical device clamp onto the upper and lower medical device clamp receiving surfaces rotationally fixes the medical device relative to the first support member connector about the first support member, and clamps the upper and lower jaws onto the first support member to rotationally fix the first support member connector about the first support member.

66. A connector system as claimed in claim 57, wherein at least one of the second support member connector, the anti-rotation arm, the first arm connection and the second arm connection permit relative lateral movement between the first support member and the second support member.

67. A connector system for connecting a medical device to a patient support device having parallel, generally horizontal first and second support members and a patient support panel disposed between the first and second support members, the first support member including an anti-rotation feature, the connector system comprising:
a first support member connector, including a medical device connector portion, and a first support member engagement portion engageable with the anti-rotation feature in such a way so as to rotationally fix the first support member connector about the first support member, and wherein the first support member connector is connectable to some other component,
wherein the medical device connector portion is sized to be gripped by a medical device connector on the medical device, and wherein the medical device connector portion has an anti-rotation feature thereon that is engageable by the medical device connector so as to fix the medical device rotationally relative to the first support member connector about the first support member.

68. A connector system as claimed in claim 67, wherein the anti-rotation feature on the medical device connector portion and the anti-rotation feature on the first support member are both engageable by the medical device connector so that the medical device connector can connect the medical device directly to the first support member and can connect the medical device to the medical device connector portion when the first support member connector is connected to the first support member.

69. A connector system as claimed in claim 67, wherein the medical device connector is a clamp.

70. A connector system as claimed in claim 67, wherein the anti-rotation feature on the medical device connector portion includes a recess that is engageable by a lug on the medical device connector.

71. A connector system as claimed in claim 67, wherein the anti-rotation feature on the medical device connector portion includes at least one flat surface that is engageable by the medical device connector.

72. A connector system as claimed in claim 67, wherein the first support member includes a plurality of support member segments connected end to end via at least one joint, wherein the at least one joint has thereon the anti-rotation feature,
the medical device connector further comprising an upper jaw and a lower jaw, wherein the upper and lower jaws are movable between a closed position and an open position, wherein in the closed position the upper and lower jaws are positioned to grip the anti-rotation feature to rotationally fix the medical device connector to one of the first and second support members.

73. A connector system as claimed in claim 72, wherein the anti-rotation feature is a recess in one of the first and second support members, and wherein one of the upper and lower jaws include a lug that is receivable in the recess sufficiently snugly to rotationally fix the medical device connector to said one of the first and second support members.
